(19) United States
(12) Patent Application Publication
(10) Pub. No.: US 2025/0198627 A1
(43) Pub. Date: Jun. 19, 2025

(54) COOKING APPARATUS

(71) Applicant: SAMSUNG ELECTRONICS CO., LTD., Suwon-si (KR)

(72) Inventors: Sooncheol KWEON, Suwon-si (KR); Bokhyun JANG, Bokhyun (KR); Soojong SHIN, Suwon-si (KR); Minho YUN, Suwon-si (KR); Seongjae JI, Suwon-si (KR)

(73) Assignee: SAMSUNG ELECTRONICS CO., LTD., Suwon-si (KR)

(21) Appl. No.: 19/073,386

(22) Filed: Mar. 7, 2025

Related U.S. Application Data
(63) Continuation of application No. PCT/KR2023/012047, filed on Aug. 14, 2023.

(30) Foreign Application Priority Data
Sep. 8, 2022 (KR) 10-2022-0114536
Feb. 3, 2023 (KR) 10-2023-0015114

(51) Int. Cl. F24C 15/00; F21V 8/00

(52) U.S. Cl. CPC F24C 15/008; G02B 6/0086

(57) ABSTRACT

A cooking apparatus includes a main body including an inner casing, a cooking chamber formed inside the inner casing, and an electrical chamber formed outside the inner casing, a heating device configured to heat the cooking chamber, a base plate arranged on an upper side of the inner casing to form an insulating layer between the electrical chamber and the inner casing, and a lighting device arranged in the electrical chamber and configured to illuminate an interior of the cooking chamber. The lighting device includes a light-emitting diode (LED) arranged on an upper side of the insulating layer, a light guide plate configured to guide light emitted from the LED from above the insulating layer to below the insulating layer, and a transparent member configured to cover an opening formed on an upper surface of the cooking chamber and to transmit light emitted through the light guide plate.

### CROSS-REFERENCE TO RELATED APPLICATIONS

This application is a continuation of International Application No. PCT/KR2023/012047, filed Aug. 14, 2023, which is incorporated herein by reference in its entirety, and claims foreign priority to Korean Application No. 10-2022-0114536, filed Sep. 8, 2022, and Korean Application No. 10-2023-0015114, filed Feb. 3, 2023, which are incorporated herein by reference in their entireties.

### TECHNICAL FIELD

The disclosure relates to a cooking apparatus.

### BACKGROUND ART

In general, a cooking apparatus is an appliance that cooks food by having a cooking chamber and a heating device that applies heat to the cooking chamber. Cooking apparatuses may include ovens, which use electric heaters or gas as heating devices, and microwaves, which use magnetrons that generates microwaves as heating devices.

Cooking apparatuses may be equipped with a camera to photograph the inside of the cooking chamber. The camera may be used to identify the type and condition of a food to be cooked, and the cooking apparatus may be controlled accordingly.

A lighting device may be provided to illuminate the inside of the cooking chamber to enable the camera to photograph the inside of the cooking chamber. The lighting device may include a light source that generates light. Typically, the light source is located adjacent to the cooking chamber such that the light emitted from the light source is directed toward the inside of the cooking chamber. To ensure that the light source located adjacent to the cooking chamber is not damaged by the high temperature inside the cooking chamber, a highly heat-resistant light source such as an incandescent lamp or a halogen lamp is used in the cooking apparatus.

### DISCLOSURE

### Technical Problem

An embodiment of the present disclosure provides a cooking apparatus that utilizes a light-emitting diode as a light source.

An embodiment of the present disclosure provides a cooking apparatus that insulates a light-emitting diode from heat in a cooking chamber to prevent the light-emitting diode from being damaged by heat in the cooking chamber.

An embodiment of the present disclosure provides a cooking apparatus that is installed such that a light-emitting diode of a lighting device is spaced apart from a cooking chamber.

An embodiment of the present disclosure provides a cooking apparatus wherein a light irradiation area of a lighting device is arranged in a rectangular or square shape to illuminate the entire area of a tray.

Technical tasks to be achieved in this document are not limited to the technical tasks mentioned above, and other technical tasks not mentioned will be clearly understood by those skilled in the art from the description below.

### Technical Solution

According to an embodiment of the present disclosure, a cooking apparatus includes a main body including an inner casing, a cooking chamber inside the inner casing, and an electrical chamber outside the inner casing, a base plate on an upper side of the inner casing and forming an insulating layer between the electrical chamber and the inner casing, and a lighting device in the electrical chamber and including a light-emitting diode (LED) on an upper side of the insulating layer, a light guide plate configured to guide light emitted from the LED from above the insulating layer to below the insulating layer, and a transparent member covering an opening on an upper surface of the cooking chamber and configured to transmit the light guided by the light guide plate to an interior of the cooking chamber to illuminate the interior of the cooking chamber.

### DESCRIPTION OF DRAWINGS

FIG. 1 is a view illustrating the exterior of a cooking apparatus according to an embodiment.

FIG. 2 is an exploded view of an outer casing of the cooking apparatus according to an embodiment.

FIG. 3 is a cross-sectional view of the cooking apparatus, according to an embodiment, from the side.

FIG. 4 is a cross-sectional view of the cooking apparatus according to an embodiment from the front.

FIG. 5 is a cross-sectional view illustrating a tray of the cooking apparatus according to an embodiment.

FIG. 6 is a cross-sectional view of a front upper portion of the cooking apparatus, according to an embodiment.

FIG. 7 is a cross-sectional view of the cooking apparatus, according to an embodiment, with an upper plate removed.

FIG. 8 is an exploded view illustrating a lighting device and its surrounding configuration in the cooking apparatus according to an embodiment.

FIG. 9 is an exploded view of the lighting device in the cooking apparatus according to an embodiment.

FIG. 10 is a view of the lighting device of FIG. 9 from a different angle.

FIG. 11 is a cross-sectional perspective view of the lighting device, in the cooking apparatus, according to an embodiment.

FIG. 12 is an enlarged view of portion A of FIG. 3.

FIG. 13 is a cross-sectional view taken along B-B′ of FIG. 11.

FIG. 14 is a view of the cooking apparatus according to an embodiment, with the upper plate removed.

FIG. 15 is a view illustrating an air flow by an electrical chamber cooling fan and an air flow by a camera cooling fan of the cooking apparatus according to an embodiment.

FIG. 16 is a view of the air flow by the electrical chamber cooling fan of the cooking apparatus according to an embodiment.

### MODES OF THE INVENTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

The terms “front”, “rear”, “left”, “right”, “up (or upper)”, “down (or lower)”, and the like used in the following description are defined with reference to the drawings, but the shape and position of each element are not limited by the above terms.

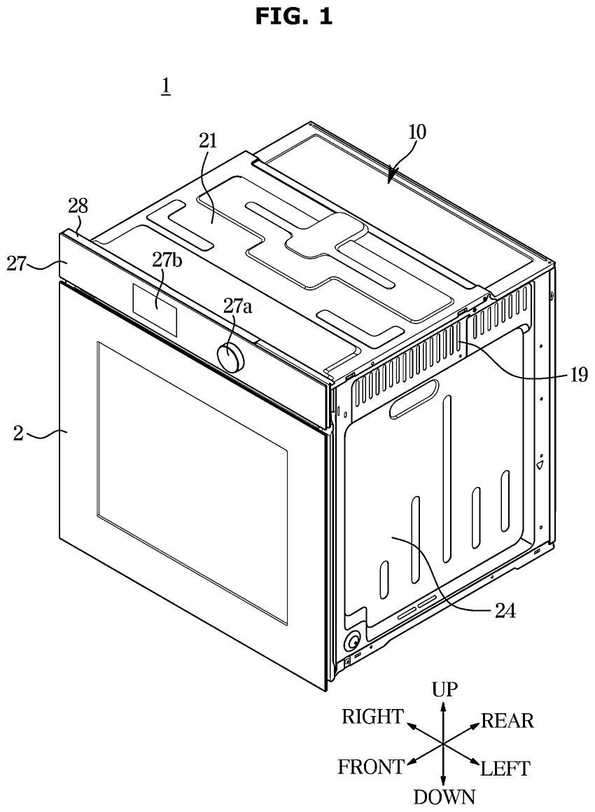

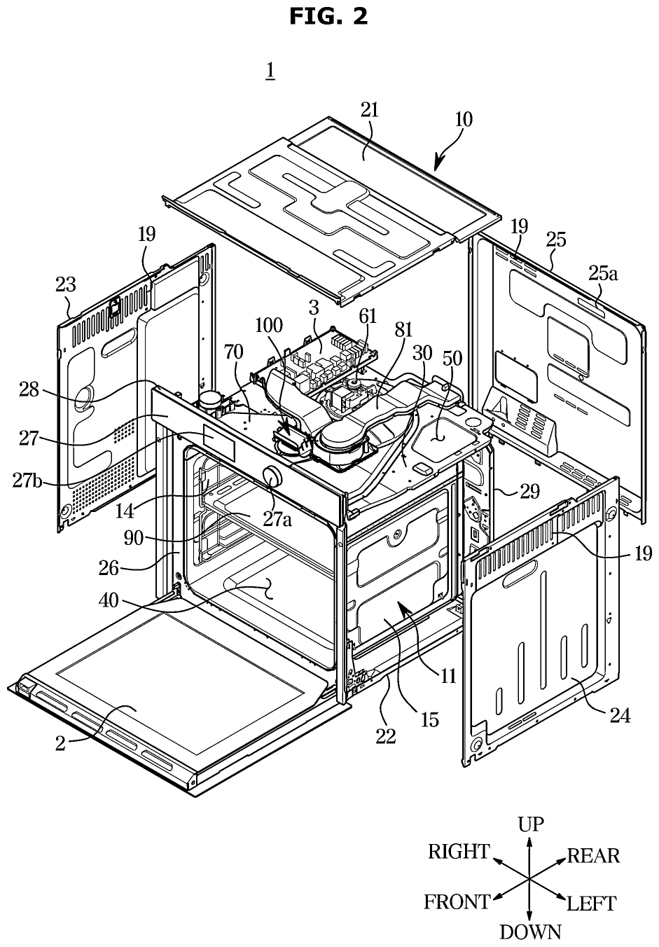

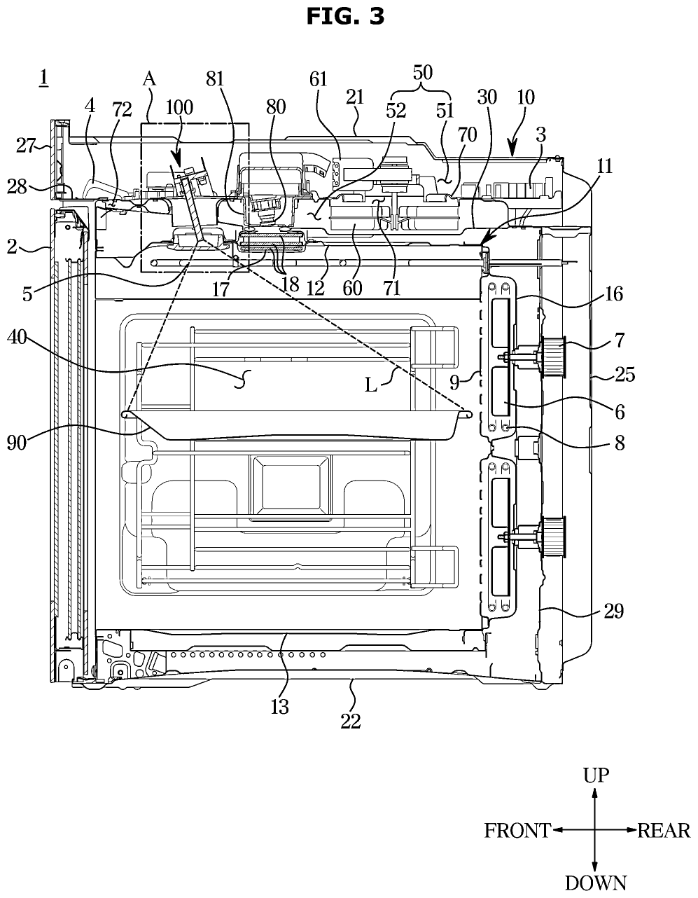

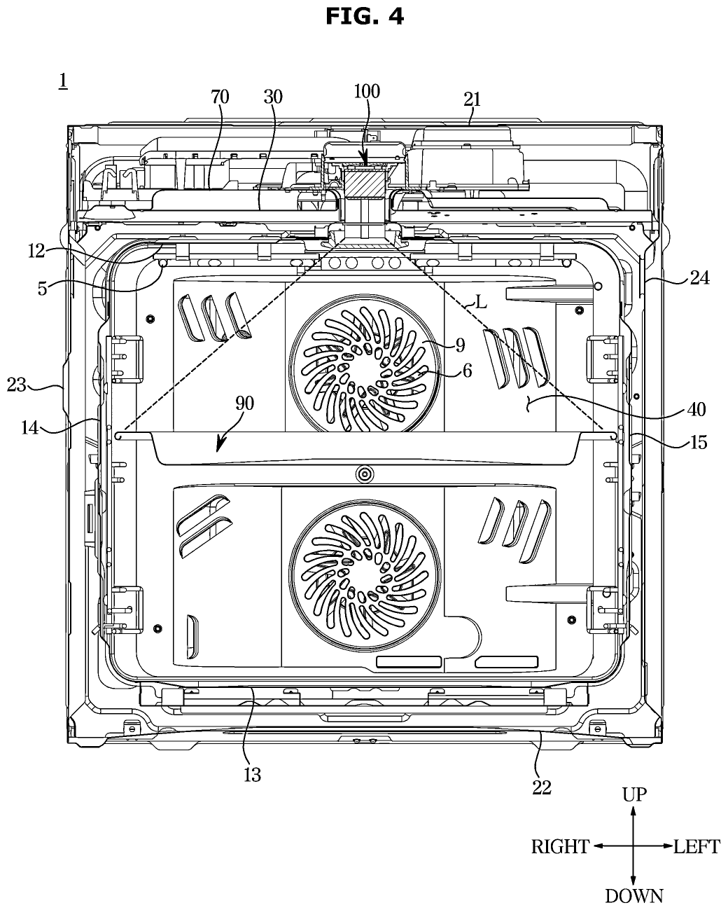

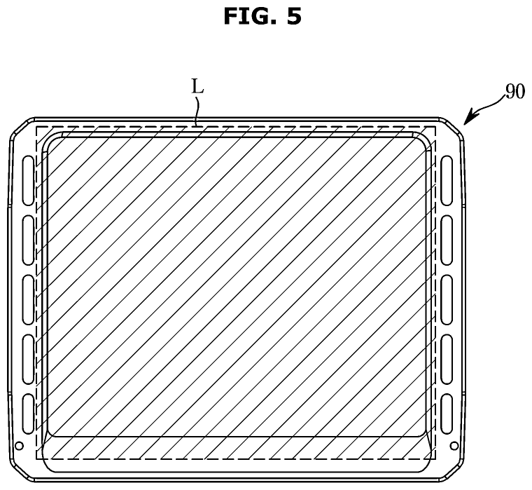

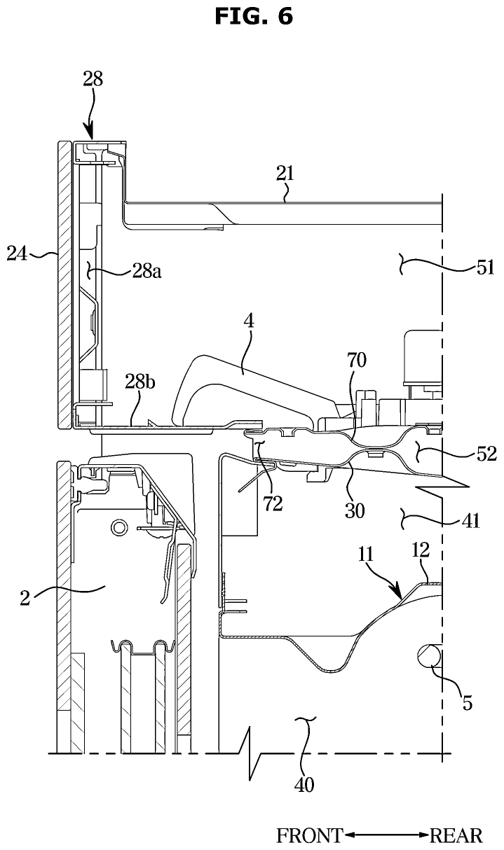

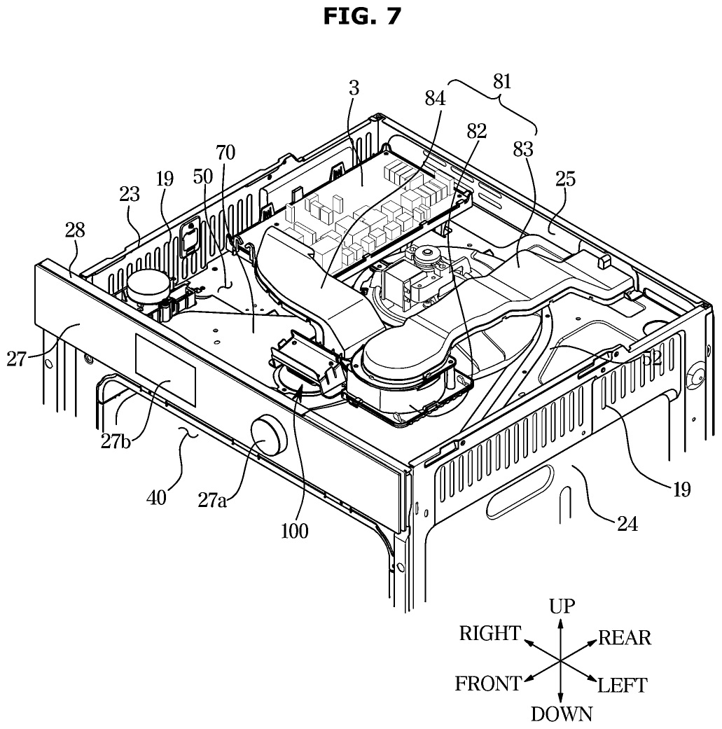

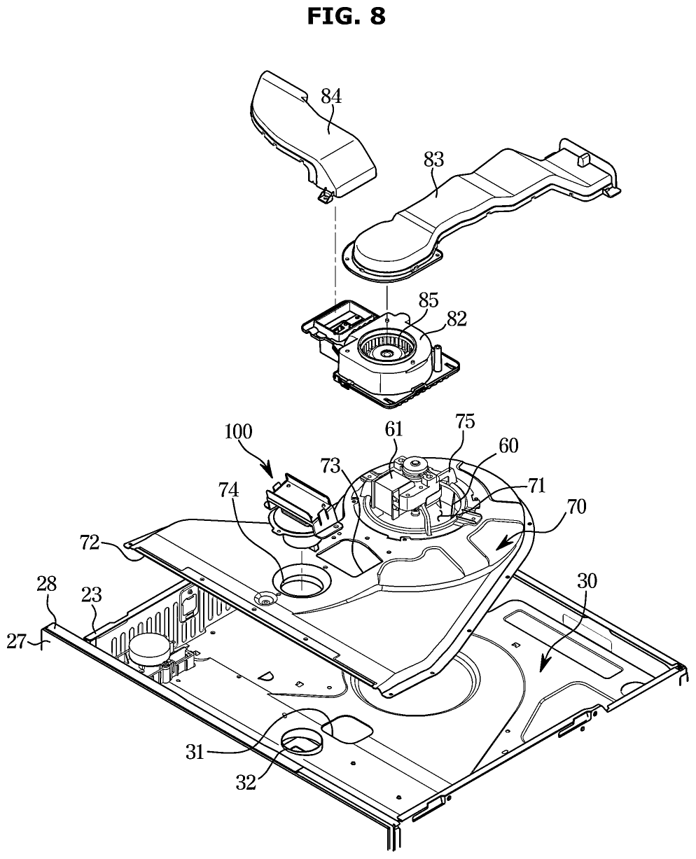

FIG. 1 is a view illustrating the exterior of a cooking apparatus according to an embodiment. FIG. 2 is an exploded view of an outer casing of the cooking apparatus according to an embodiment. FIG. 3 is a cross-sectional view of the cooking apparatus, according to an embodiment, from the side. FIG. 4 is a cross-sectional view of the cooking apparatus according to an embodiment from the front. FIG. 5 is a cross-sectional view illustrating a tray of the cooking apparatus according to an embodiment. FIG. 6 is a cross-sectional view of a front upper portion of the cooking apparatus, according to an embodiment. FIG. 7 is a cross-sectional view of the cooking apparatus, according to an embodiment, with an upper plate removed. FIG. 8 is an exploded view illustrating a lighting device and its surrounding configuration in the cooking apparatus according to an embodiment.

As shown in FIGS. 1 to 8, a cooking apparatus 1 may include a main body 10 including an inner casing 11, a cooking chamber 40 formed on an inside of the inner casing 11, and an electrical compartment chamber 50 (hereinafter referred to as an electrical chamber) formed on an outside of the inner casing 11.

The inner casing 11 may partition the cooking chamber 40 and the electrical chamber 50. The inner casing 11 may have an approximately box shape. The inner casing 11 may include an upper wall 12, a lower wall 13, a left wall 14, a right wall 15, and a rear wall 16.

The cooking chamber 40 may cook food items at a high temperature. The cooking chamber 40 may be formed to be open at a front side to allow food items to be taken in and out. The cooking chamber 40 may be provided with heating devices 5 and 8 to heat the cooking chamber 40. The heating devices 5 and 8 may include electric heaters having heating element that heat up when electrically energized. However, the heating devices 5 and 8 are not limited thereto, and may include gas burners using gas to generate heat, or magnetrons generating microwaves.

The heating devices 5 and 8 may include an upper heating device 5 and a fan heating device 8. The upper heating device 5 may be arranged on an upper portion of the cooking chamber 40 to heat food items thereon. The fan heating device 8 may be arranged around a convection fan 6 that convects air inside the cooking chamber 40.

According to an embodiment, the cooking apparatus 1 may be provided with at least one of the upper heating device 5 and the fan heating device 8. In addition, the cooking apparatus 1 may further be provided with a lower heating device arranged at a lower portion of the cooking chamber 40.

The cooking chamber 40 may be provided with the convection fan 6 for convectively flowing air inside the cooking chamber 40. The convection fan 6 may be arranged on a rear side of the cooking chamber 40. The convection fan 6 may be covered and protected by a fan cover 9. The fan cover 9 may be coupled to the rear wall 16 of the inner casing 11. The fan cover 9 may have a through-hole for an air flow. The convection fan 6 may be driven by a convection fan motor 7. The convection fan motor 7 may be supported on a support plate 29 arranged between the rear wall 16 of the inner casing 11 and a rear plate 25 of an outer casing.

A tray 90 on which food to be cooked may be placed may be positioned in the cooking chamber 40. The tray 90 may be detachably mounted on a rack 91 installed on both side walls of the cooking chamber 40. The tray 40 may be configured to be pulled out from the front of the cooking chamber 40. Although not shown in the drawings, the tray 90 may be arranged to be height-adjustable within the cooking chamber 40. The rack 91 may include a plurality of levels of different heights, and the tray 90 may be mounted on any one of the levels of the rack. This may allow the tray 90 to be positioned at different heights within the cooking chamber 40. For example, the tray 90 may be positioned at any one of the first to fifth levels within the cooking chamber 40.

Various electrical components, such as a circuit board 3 that controls an operation of the cooking apparatus 1 may be positioned within the electrical chamber 50. According to an embodiment, the electrical chamber 50 may be provided with a steam generating device (not shown) that generates steam. According to an embodiment, the electrical chamber 50 may be provided with an automatic opening/closing device (not shown) that automatically opens and closes a door 2.

The electrical chamber 50 may be formed to surround the cooking chamber 40. The electrical chamber 50 may provide thermal insulation between the cooking chamber 40 and the outer casing of the main body 10 to prevent heat inside the cooking chamber 40 from escaping to the outside of the main body 10. Air may flow into the electrical chamber 50 for insulation. In the electrical chamber 50, a separate insulation (not shown) may be configured to surround the inner casing 11 for insulation. The insulation may be made of glass fiber, asbestos, or the like.

The main body 10 may include the outer casing forming the exterior of the cooking apparatus 1. The inner casing 11 may be accommodated in the outer casing. The electrical chamber 50 may be formed between the inner casing 11 and the outer casing. The outer casing may include an upper plate 21, a lower plate 22, a left plate 23, a right plate 24, a rear plate 25, and a front plate 26. The left plate 23, the right plate 24, the rear plate 25, and the like may have a through-hole 19 to allow air to flow into the electrical chamber 50. Depending on the embodiment, the through-hole 19 may also be formed in the upper plate 21 or the lower plate 22.

The cooking apparatus 1 may include a control panel 27. The control panel 27 may include an operating portion 27a on which a user may input operation commands, and a display portion 27b on which various operation information of the cooking apparatus 1 may be displayed. Although the operating portion 27a is shown as a dial type in the drawings, but the present disclosure is not limited thereto. For example, the operating portion may be provided in the form of a touch display. In this case, the operating portion and the display portion may be integrally formed.

Referring to FIG. 6, the control panel 27 may be provided on an upper front side of the cooking apparatus 1. The control panel 27 may be mounted on a panel bracket 28 coupled to the main body 10. The control panel 27 may be mounted on a front surface of the panel bracket 28. The panel bracket 28 may include a bracket opening 28a such that at least a portion of a rear surface of the control panel 27 may be cooled by an electrical chamber cooling fan 60. A bottom portion 28b of the panel bracket 28 may be positioned on a front side of an electrical chamber duct 70 at a height corresponding to an upper surface of the electrical chamber duct 70. The bottom portion 28b of the panel bracket 28 may guide air discharged to the front side of the main body 10 through an outlet 72 of the electrical chamber duct 70.

The cooking apparatus 1 may include the door 2 arranged on the front surface of the main body 10 to open or close the cooking chamber 40. The door 2 may be rotatably arranged on the front surface of the main body 10. The door 2 may be configured to open or close by rotating an up-and-down direction about a lower end.

The electrical chamber 50 may be provided with a locking device 4 configured to lock the door 2 to the main body 10 such that the door 2 remains closed.

The cooking apparatus 1 may include a base plate 30 arranged in the electrical chamber 50 on which various components of the electrical chamber 50 are installed. The base plate 30 may be arranged on an upper side of the inner casing 11 and spaced apart from the inner casing 11 by a predetermined distance. The insulation described above (not shown) may be arranged between the base plate 30 and the upper wall 12 of the inner casing 11. Alternatively, the air between the upper wall 12 of the inner casing 11 and the base plate 30 may form an insulating layer 41. The insulating layer 41 may insulate between the cooking chamber 40 and the electrical chamber 50 to prevent heat inside the cooking chamber 40 from being released directly to the outside of the cooking chamber 40.

The electrical chamber duct 70 may be coupled to an upper surface of the base plate 30. The electrical chamber duct 70 may cover a portion of the base plate 30. The electrical chamber duct 70 may partition the electrical chamber 50 into an electrical component space 51 and an exhaust space 52. The exhaust space 52 may be formed between the electrical chamber duct 70 and the base plate 30. In other words, the exhaust space 52 may refer to an inner space of the electrical chamber duct 70. The electrical component space 51 may refer to an outer space of the electrical chamber duct 70 inside the main body 10.

The base plate 30 may include a first plate opening 31 formed to allow a camera 80 to photograph the cooking chamber 40. The first plate opening 31 may be formed at a position corresponding to a viewing portion 17 arranged on the upper wall 12 of the inner casing 11.

The base plate 30 may include a second plate opening 32 formed to allow a lighting device 100 to illuminate the interior of the cooking chamber 40. The second plate opening 32 may be formed on the upper wall 12 of the inner casing 11. The second plate opening 32 may be located in front of the first plate opening 31.

The electrical chamber duct 70 may include an inlet 71 through which air is drawn in from the electrical component space 51 to the exhaust space 52. The electrical chamber duct 70 may include the outlet 72 formed to allow air from the exhaust space 52 to be discharged to the outside of the electrical chamber duct 70. The air from the electrical chamber 50 may be discharged to the outside of the main body 10 through the electrical chamber duct 70. The outlet 72 may be formed on a front side of the electrical chamber duct 70. Accordingly, the air in the electrical chamber 50 may be discharged to the front side of the main body 10.

The electrical chamber duct 70 may include a housing duct opening 73 through which at least a portion of a housing 82 of a camera cooling duct 81 passes, and a lighting duct opening 74 through which at least a portion of the lighting device 100 passes.

The cooking apparatus 1 may include the electrical chamber cooling fan 60 configured to cool the electrical chamber 50. The electrical chamber cooling fan 60 may be driven by an electrical chamber cooling fan motor 61. The electrical chamber cooling fan motor 61 may be mounted on a motor mount 75 coupled to the electrical chamber duct 70. The electrical chamber cooling fan 60 may cool the electrical chamber 50 by flowing air into the electrical chamber 50.

The electrical chamber cooling fan 60 may be arranged in the electrical chamber 50. The electrical chamber cooling fan 60 may be arranged adjacent to the inlet 71 of the electrical chamber duct 70. The electrical chamber cooling fan 60 may include a centrifugal fan that draws in air in an axial direction and discharges air in a radial direction.

The electrical chamber cooling fan 60 may draw air from outside the main body 10 into the electrical chamber 50 through the through-holes 19 formed in the left plate 23, the right plate 24, the rear plate 25, and the like. The electrical chamber cooling fan 60 may cool the entire electrical chamber 50 by forming a flow of air throughout the electrical chamber 50.

In response to operation of the electrical chamber cooling fan 60, air from outside the main body 10 may be drawn into the electrical component space 51 of the electrical chamber 50. In response to the operation of the electrical chamber cooling fan 60, the air drawn into the electrical component space 51 may flow into the exhaust space 52 formed between the electrical chamber duct 70 and the base plate 30. The air drawn into the exhaust space 52 may be discharged to the front side of the main body 10 through the outlet 72. As described above, in response to the operation of the electrical chamber cooling fan 60, air from outside the main body 10 at a relatively low temperature may be drawn into the main body 10, pass through the electrical component space 51 and the exhaust space 52 to cool the components within the electrical chamber 50, and then be discharged to the outside of the main body 10. During the operation of the electrical chamber cooling fan 60, the air flow passing through the exhaust space 52 may cool the components within the exhaust space 52. For example, the air flow passing through the exhaust space 52 may cool the lighting device 100. As used herein, the exhaust space 52 may be referred to as a cooling air layer 52 or a cooling flow path 52.

The cooking apparatus 1 may include the camera 80 capable of photographing the interior of the cooking chamber 40. The camera 80 may be positioned within the electrical chamber 50. The camera 80 may photograph the interior of the cooking chamber 40 through the upper wall 12 of the inner casing 11. To this end, the upper wall 12 of the inner casing 11 may include the viewing portion 17 through which the camera 80 may look. The camera 80 may be arranged above the viewing portion 17 to photograph the interior of the cooking chamber 40 through the viewing portion 17.

The cooking apparatus 1 may include a camera cooling fan 85 configured to intensively cool the camera 80. The cooking apparatus 1 may include the camera cooling duct 81 that guides the air from outside the main body 10 to the camera 80 and the electrical component space 51 of the electrical chamber 60 in response to operation of the camera cooling duct 81. The camera cooling duct 81 may guide the air from outside the main body 10 to the camera 80 to cool the camera 80. The camera cooling duct 81 may guide the air that cools the camera 80 into the electrical component space 51 of the electrical chamber 50.

The cooking apparatus 1 may include the lighting device 100 configured to brightly illuminate the cooking chamber 40 when the camera 80 photographs the cooking chamber 40. According to an embodiment, the lighting device 100 may be positioned in front of the camera 80. The lighting device 100 may be positioned in front of the camera 80 so as not to interfere with the camera 80. The lighting device 100 and the camera 80 may be spaced apart from each other along a front-to-back direction.

The lighting device 100 may be positioned approximately at the center in the left-to-right direction within the electrical chamber 50. The lighting device 100 may be positioned close to a front end of the electrical chamber 50. The lighting device 100 may be positioned close to the control panel 27 within the electrical chamber 50 and approximately at the center relative to the left-to-right direction.

The lighting device 100 may be installed to penetrate the electrical chamber duct 70 and the base plate 30. The lighting device 100 may include a light source, such as a light-emitting diode (LED) and a light guide plate for guiding the light emitted from the light source. The detailed configuration of the lighting device 100 will be described later.

Referring to FIGS. 3 to 5, the lighting device 100 of the cooking apparatus 1 according to the present disclosure may illuminate substantially the entire area of the tray 90.

Referring to FIG. 3, the lighting device 100 may illuminate an upper surface of the tray 90 receiving food from a front end to a rear end. In other words, a light irradiation area L of the lighting device 100 may be from the front end to the rear end of the tray 90.

Referring to FIG. 4, the lighting device 100 may illuminate the upper surface of the tray 90 from a left end to a right end. In other words, the light irradiation area L of the lighting device 100 may be from the left end to the right end of the tray 90.

Referring to FIG. 5, the light irradiation area L of the lighting device 100 may be the entire upper surface of the tray 90. The light irradiation area L of the lighting device 100 may be approximately rectangular or square when viewed from above. In general, the upper surface of the tray 90 for receiving food may be provided in a rectangular or square shape. According to the present disclosure, the light irradiation area L of the lighting device 100 may be rectangular or square, and accordingly, the lighting device 100 may illuminate the entire upper surface of the tray 90. In other words, this may eliminate a blind spot on the tray 90 where no light is provided.

As shown in FIGS. 7 and 8, the camera cooling duct 81 may include the housing 82, an intake duct 83 coupled to one side of the housing 82, and a discharge duct 84 coupled to the other side of the housing 82.

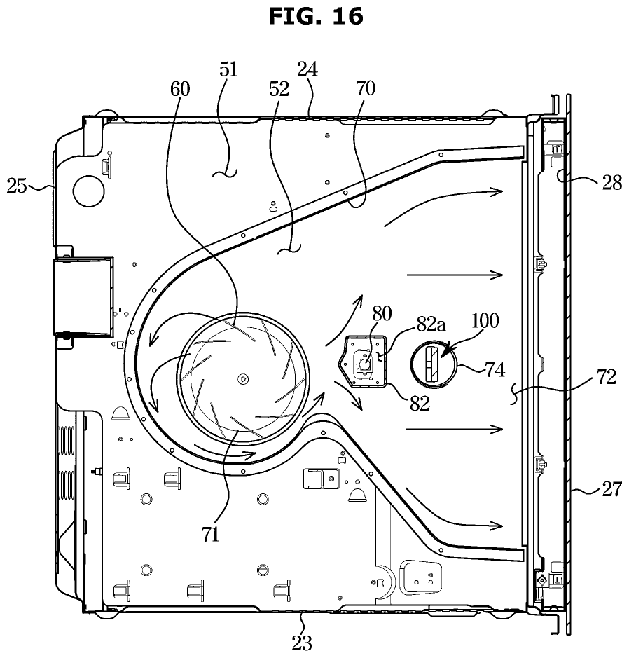

The housing 82 may be coupled to the upper surface of the electrical chamber duct 70. The housing 82 may include a camera receiving space 82a (see FIG. 16) that accommodates the camera 80. The camera 80 may be accommodated in the camera receiving space 82a formed within the housing 82.

The camera 80 accommodated in the camera receiving space 82a may photograph the interior of the cooking chamber 40 through the viewing portion 17.

The viewing portion 17 may include at least one or more glasses 18 (see FIG. 3) mounted in the opening of the upper wall 12. The at least one or more glasses 18 may be provided as heat-resistant tempered glass, borosilicate glass, or the like. An air insulating layer may be formed between at least one or more glasses 18. However, the viewing portion 17 may include other heat-resistant and visible materials as well as glass.

The intake duct 83 may be coupled to the housing 82 to draw in air from the outside of the main body 10 and guide the drawn-in air to the housing 82. The intake duct 83 may in air from the outside of the main body 10, which may be at a relatively lower temperature than the electrical chamber 50.

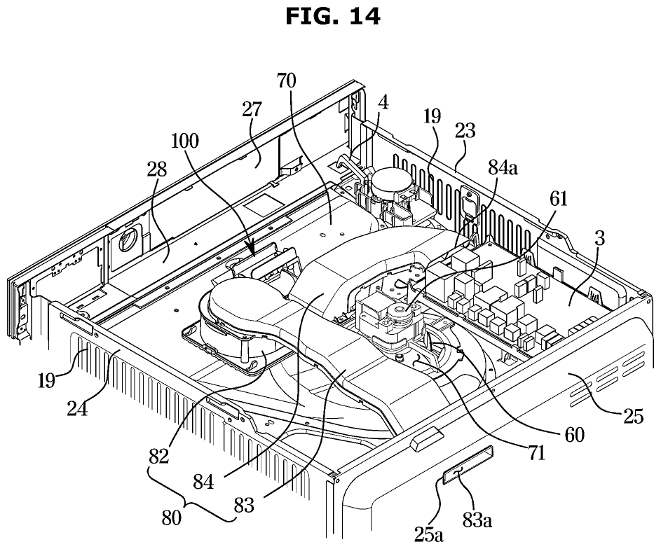

The intake duct 83 may be coupled to the rear plate 25 forming the rear surface of the main body 10. The rear plate 25 may have an outside air inlet 25a (see FIG. 14) formed therein for drawing in air from the outside of the main body 10. The outside air inlet 25a may be formed to be more recessed than the surroundings of the outside air inlet 25a so that outside air may be efficiently drawn in. The outside air inlet 25a may be formed to be recessed 3 mm or more than the surroundings of the outside air inlet 25a.

The intake duct 83 may draw in outside air from the rear side of the main body 10. An inlet 83a (see FIG. 14) of the intake duct through which air is drawn in may be formed at one end of the intake duct 83. The inlet 83a of the intake duct may be connected to the outside air inlet 25a of the rear plate 25.

The discharge duct 84 may be coupled to the housing 82 to discharge air that has cooled the camera 80 from the housing 82. The discharge duct 84 may discharge air into the electrical component space 51 of the electrical chamber 50. By allowing the discharge duct 84 to discharge air into the electrical component space 51, the air discharged from the discharge duct 84 may not collide with or merge with the air discharged forwardly along the exhaust space 52 of the electrical chamber duct 70 by the blowing force of the electrical chamber cooling fan 60. Accordingly, the cooling efficiency of the electrical chamber by the electrical chamber cooling fan 60 and the electrical chamber duct 70 may not be degraded.

The discharge duct 84 may discharge air toward the circuit board 3 disposed in the electrical compartment space 51. To this end, an outlet 84a (see FIG. 14) of the discharge duct through which air is discharged may be formed at one end of the discharge duct 84. The outlet 84a of the discharge duct may discharge air toward the circuit board 3 side. The circuit board 3 may be a relatively heat-sensitive electrical component. As described above, the air flowing by the camera cooling fan 85 may have a relatively lower temperature than the air flowing by the electrical chamber cooling fan 60 because it is directly drawn in from the outside of the main body 10. As such, by providing the low temperature air flowing by the camera cooling fan 85 to the circuit board 3 side, the circuit board 3, which is susceptible to heat, may be cooled efficiently.

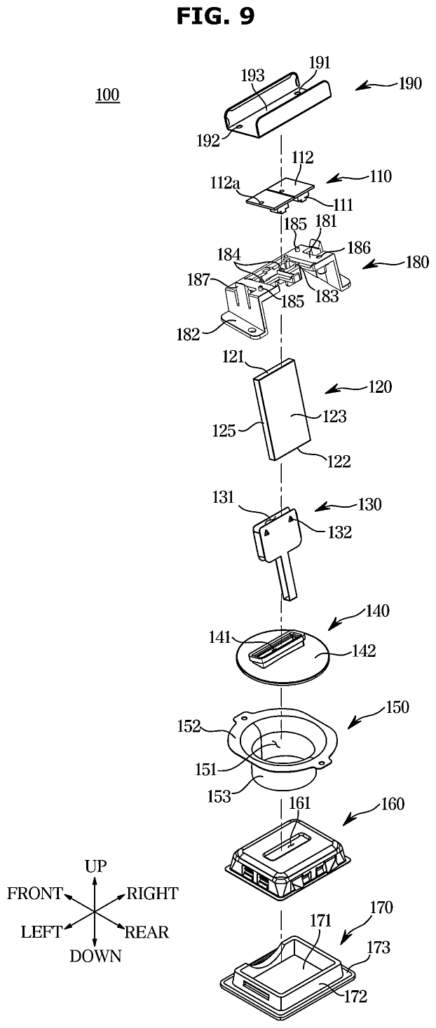

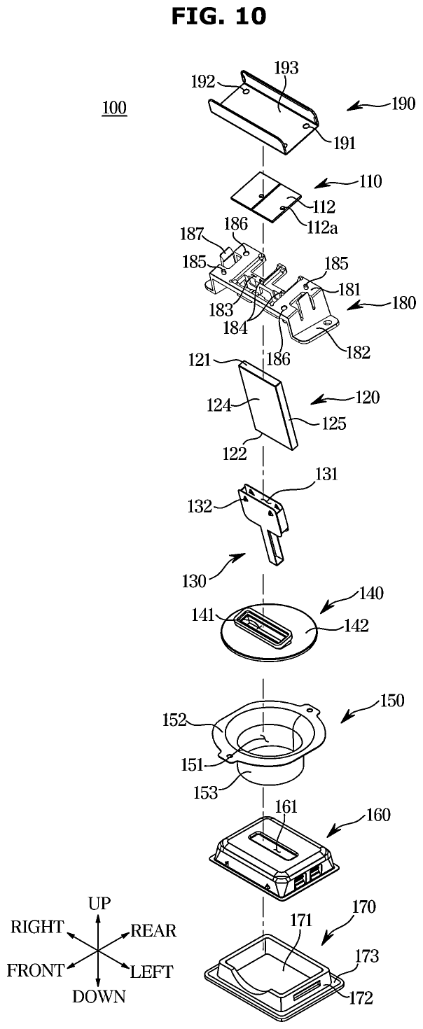

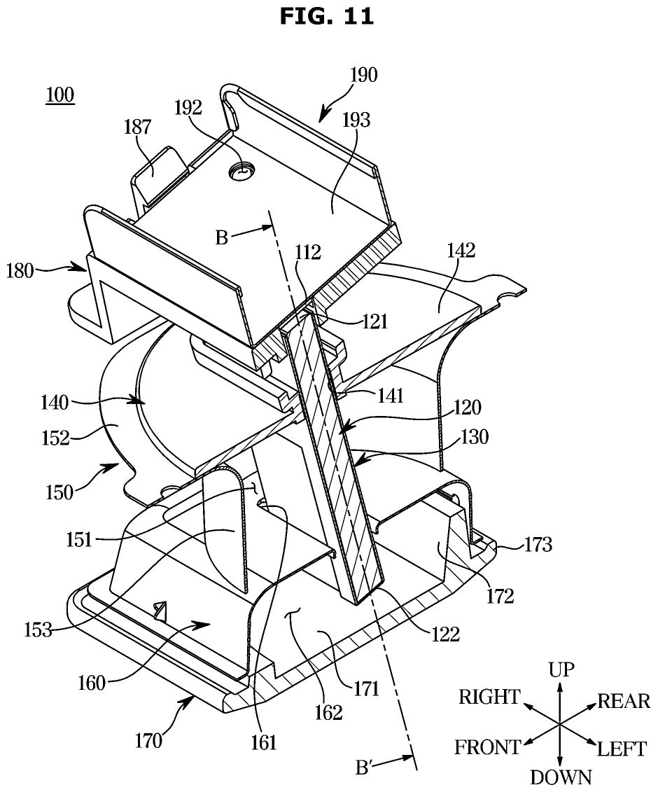

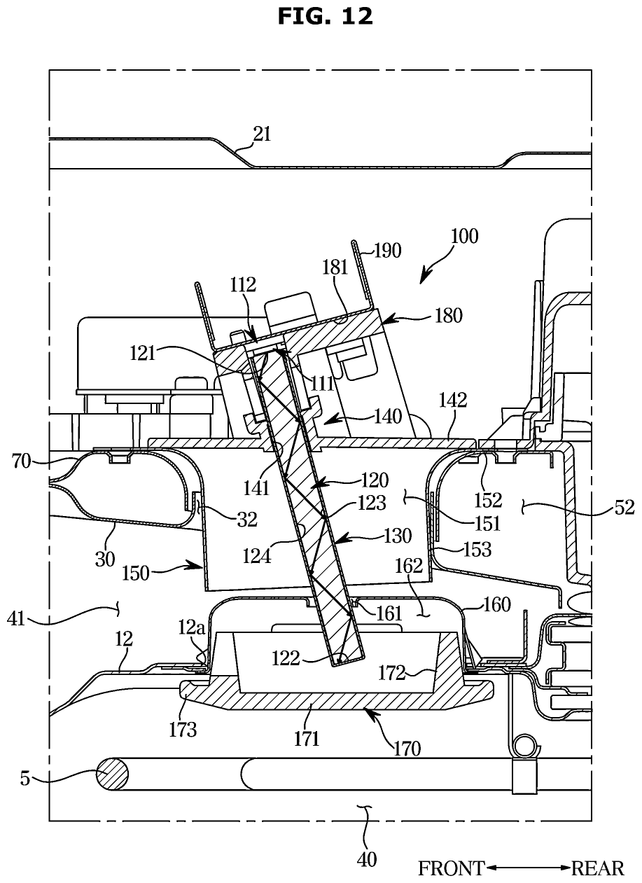

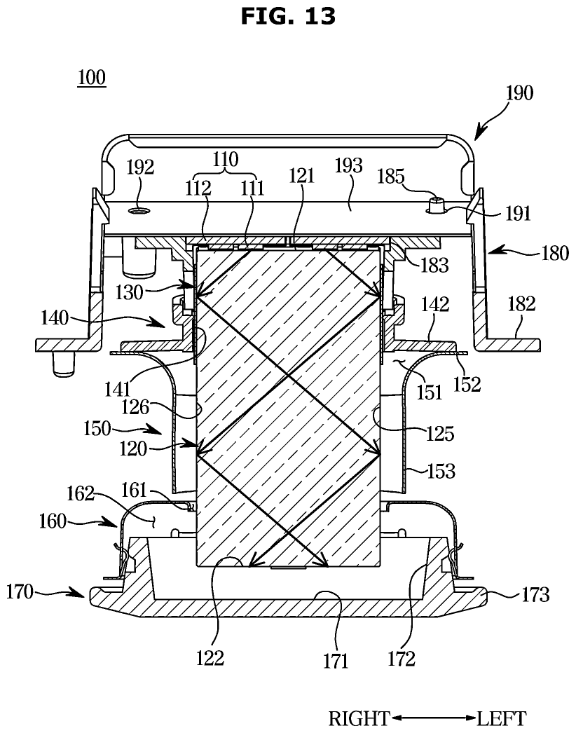

FIG. 9 is an exploded view of the lighting device in the cooking apparatus according to an embodiment. FIG. 10 is a view of the lighting device of FIG. 9 from another angle. FIG. 11 is a cross-sectional perspective view of the lighting device in the cooking apparatus according to an embodiment. FIG. 12 is an enlarged view of portion A of FIG. 3. FIG. 13 is a cross-sectional view taken along B-B′ of FIG. 11.

In the following, with reference to FIGS. 9 to 13, the lighting device 100 of the cooking apparatus 1 according to the present disclosure will be described in detail.

Referring to FIGS. 9 to 11, the lighting device 100 may include a light source device 110 that generates light, and a light guide plate 120 that transmits the light generated by the light source device 110.

The light source device 110 may include an LED 111 as a light source and a substrate 112 on which the LED 111 is mounted.

The LED 111 may have advantages over a conventional light source, such as an incandescent lamp or a halogen lamp, in that it may realize bright, natural colors and different colors, and has low power consumption. However, the LED 111 has disadvantages in that it is sensitive to high temperatures compared to incandescent or halogen lamps.

The latest cooking apparatus 1 may include a self-cleaning function, and, for example, include a pyrolytic cleaning function. Pyrolytic cleaning may refer to a function that raises the temperature inside the cooking chamber to 400° C. or higher and burns foreign substances inside the cooking chamber to turn them into ashes. When pyrolytic cleaning is performed, the temperature inside the cooking chamber 40 may be raised to 400° C. or higher. Accordingly, in response to the heat inside the cooking chamber 40 being transferred to the lighting device 100, the LED 111, which is susceptible to high temperatures, may be damaged. According to the present disclosure, damage to the LED 111 may be prevented by minimizing the transfer of heat inside the cooking chamber 40 to the LED 111. Further, overheating of the LED 111 may be prevented by cooling the LED 111 through the cooling flow path.

According to an embodiment, the lighting device 100 may include a plurality of LEDs 111. The lighting device 100 may include four LEDs 111. The four LEDs 111 may be arranged to be spaced apart from each other in a row. Specifically, the four LEDs 111 may be arranged in a row along the left-to-right direction.

The LEDs 111 may be mounted on the substrate 112. The substrate 112 may include a substrate hole 112a. A fixing protrusion 184 of a support bracket 180, which will be described later, may be inserted into the substrate hole 112a. By inserting the first fixing protrusion 184 into the substrate hole 112a, the substrate 112 may be fixed to the support bracket 180.

The light guide plate 120 may be configured to transmit light generated by the LEDs 111. The light guide plate 120 may be provided in an approximately cuboidal shape. The light guide plate 120 may include an incoming light portion 121 arranged to face the LEDs 111, and an outgoing light portion 122 that emits light incident on the incoming light portion 121. The light guide plate 120 may be configured to guide light incident on the incoming light portion 121 to the outgoing light portion 122. The incoming light portion 121 may refer to a surface of the light guide plate 120 arranged to face the LEDs 111. The outgoing light portion 122 may refer to a surface of the light guide plate 120 arranged to face the incoming light portion 121.

The light guide plate 120 may include first to fourth reflective portions 123, 124, 125 and 126. The first reflective portion 123 and the second reflective portion 124 may totally reflect light within the light guide plate 120 in the front-to-back direction. The third reflective portion 125 and the fourth reflective portion 126 may totally reflect light within the light guide plate 120 in the left-to-right direction.

The lighting device 100 may include a light guide plate case 130 configured to receive the light guide plate 120.

The light guide plate case 130 may be configured to receive the light guide plate 120. The light guide plate case 130 may be coupled to the support bracket 180. By coupling the light guide plate case 130 to the support bracket 180, the light guide plate 120 received in the light guide plate case 130 may be coupled to the support bracket 180. The light guide plate 120 may be coupled to the support bracket 180 together with the light guide plate case 130.

The light guide plate case 130 may include a light guide plate receiving groove 131 that receives the light guide plate 120. The light guide plate receiving groove 131 may be provided in a form in which one side is open. The light guide plate 120 may be inserted into the light guide plate case 130 through the open side of the light guide plate receiving groove 131.

The light guide plate case 130 may include a case protrusion 132. The case protrusion 132 may protrude outwardly from an outer surface of the light guide plate case 130. The case protrusion 132 may be positioned adjacent to an upper end of the light guide plate case 130. By positioning the case protrusion 132 adjacent to an upper end of the light guide plate case 130, a majority of the light guide plate case 130 may pass through a light guide plate hole 188 of the support bracket 180. The case protrusion 132 may prevent the light guide plate case 130 from passing through the light guide plate hole 188 of the support bracket 180, which will be described later. The case protrusions 132 may be caught on the surroundings of the light guide plate hole 188, thereby preventing the light guide plate case 130 from passing through the light guide plate hole 188 of the support bracket 180. In addition, by preventing the case protrusion 132 from passing through the light guide plate hole 188, the light guide plate case 130 may be maintained in a state of being coupled to the support bracket 180.

The light guide plate case 130 may be configured to include a metallic material. The light guide plate case 130 may have a high thermal conduction efficiency by including a metallic material. The light guide plate case 130 may effectively dissipate heat from the light guide plate 120 to the outside by being made of a material having a high thermal conduction efficiency. The light guide plate case 130 may contact the surrounding air to dissipate heat to the surrounding air.

The lighting device 100 may include a first light barrier 140. The first light barrier 140 may be configured to block a portion of the light emitted through the light guide plate 120 from being directed into the electrical chamber 50.

The first light barrier 140 may include an insertion hole 141 into which the light guide plate 120 and the light guide plate case 130 are inserted. The light guide plate 120 may pass through the insertion hole 141 while being received in the light guide plate case 130. At least a portion of the light guide plate 120 and the light guide plate case 130 may pass through the insertion hole 141 and be positioned below the first light barrier 140. The outgoing light portion 122 of the light guide plate 120 may pass through the insertion hole 141 and be positioned below the first light barrier 140.

The first light barrier 140 may include a light blocking portion 142 configured to block light. The light blocking portion 142 may be configured to prevent transmission of light. The light blocking portion 142 may prevent light below the light blocking portion 142 from transmitting above the light blocking portion 142. Accordingly, the first light barrier 140 may prevent light emitted through the light guide plate 120 from being emitted into the electrical chamber 50. The light blocking portion 142 may be provided in an approximately circular shape. The insertion hole 141 described above may be formed on one side of the light blocking portion 142. The light blocking portion 142 may be made of an elastic material. For example, the light blocking portion 142 may be configured to include a material such as rubber, silicone, or the like.

The lighting device 100 may include a second light barrier 150. The second light barrier 150 may prevent light emitted through the first to fourth reflective portions 123, 124, 125 and 126 of the light guide plate 120 from leaking out of the second light barrier 150.

The second light barrier 150 may include a connection hole 151 through which the light guide plate 120 and the light guide plate case 130 are arranged to pass. The second light barrier 150 may include a passage portion 153 arranged in a cylindrical shape to form the connection hole 151. The passage portion 153 may surround the first to fourth reflective portions 123, 124, 125 and 126 of the light guide plate 120, thereby preventing light emitted through the first to fourth reflective portions 123, 124, 125 and 126 from leaking out of the passage portion 153.

The second light barrier 150 may include a flange portion 152 configured to support an edge of the light blocking portion 142. The light blocking portion 142 may not pass through the connection hole 151 and may be supported by the flange portion 152. The outer diameter of the light blocking portion 142 may be larger than the diameter of the connection hole 151 to prevent the light blocking portion 142 from passing through the connection hole 151.

A portion of the light guide plate 120 and the light guide plate case 130 that have passed through the insertion hole 141 may be positioned within the connection hole 151. The remaining portion of the light guide plate 120 and the light guide plate case 130 that have passed through the insertion hole 141 may pass through the connection hole 151 and be positioned outside of the passage portion 152.

The lighting device 100 may include a light reflector 160 and a transparent member 170. The light reflector 160 may reflect light, which is reflected without passing through the transparent member 170, back toward the transparent member 170. The transparent member 170 may be inserted into an upper wall opening 12a formed in the upper wall 12 of the inner casing 11, thereby blocking or reducing heat inside the cooking chamber 40 from being transferred to the LEDs 111 through the upper wall opening 12a.

The transparent member 170 may be positioned on an upper surface of the cooking chamber 40. The transparent member 170 may cover the upper wall opening 12a, thereby blocking or reducing heat inside the cooking chamber 40 from being transferred to the outside of the cooking chamber 40 through the upper wall opening 12a. The transparent member 170 may transmit light such that the light emitted outside of the light guide plate 120 may illuminate the interior of the cooking chamber 40. The transparent member 170 may be made of a material that allows light to pass through. The transparent member 170 may be transparent.

The transparent member 170 may include a transmission portion 171 that transmits light. The transmission portion 171 may further evenly distribute the light emitted from the light guide plate 120. To this end, the transmission portion 171 may include a scattering surface.

The transparent member 170 may include an insertion rib 172 arranged to be inserted into the upper wall opening 12a. The insertion rib 172 may be arranged along an edge of the transmission portion 171. The insertion rib 172 may be formed to protrude upwardly along the edge of the transmission portion 171. The insertion rib 172 may be inserted into the upper wall opening 12a and coupled to the upper wall 12.

The transparent member 170 may include a flange 173 protruding laterally along the edge of the transmission portion 171 of the insertion rib 172. The provision of the flange 173 may prevent the transparent member 170 from passing through the upper wall opening 12a. The transmission portion 171 and the flange 173 may be integrally formed. The transmission portion 171 and the flange 173 may be formed of the same material. The transmission portion 171 and the flange 173 may be arranged to be larger than the upper wall opening 12a. The transmission portion 171 and the flange 173 may cover the upper wall opening 12a. The transmission portion 171 and the flange 173 may cover the upper wall opening 12a, so that the transparent member 170 may block or reduce the transfer of heat inside the cooking chamber 40 to the outside of the cooking chamber 40 through the upper wall opening 12a.

The light reflector 160 may be coupled with the transparent member 170 to form an internal space 162. The outgoing light portion 122 of the light guide plate 120 may be positioned in the internal space 162. The light reflector 160 may be provided in a cube shape with one side open. The insertion rib 172 of the transparent member 170 may be inserted into the inner side of the light reflector 160 through the open side of the light reflector 160. By inserting the insertion rib 172 of the transparent member 170 into the inner side of the light reflector 160, the transparent member 170 and the light reflector 160 may be coupled.

An inner surface of the light reflector 160 may be configured to reflect light. The inner surface of the light reflector 160 may refer to a surface of the light reflector 160 located in the internal space 162. The inner surface of the light reflector 160 may be coated with a highly reflective paint. Alternatively, the entirety of the light reflector 160 may be configured to include a material having a high reflectivity.

The light reflector 160 may include a reflector hole 161. At least a portion of the light guide plate 120 and the light guide plate case 130 may be inserted into the reflector hole 161. At least a portion of the light guide plate 120 and the light guide plate case 130 may pass through the reflector hole 161. The portions of the light guide plate 120 and the light guide plate case 130 that have passed through the reflector hole 161 may be located in the internal space 162. The temperature of the internal space 162 may be relatively high because the internal space 162 is adjacent to the cooking chamber 40. To minimize the temperature rise of the light guide plate 120 and the light guide plate case 130 located in the internal space 162, it is desirable to minimize the light guide plate 120 and the light guide plate case 130 located in the internal space 162. In other words, only portions of the lower ends of the light guide plate 120 and the light guide plate case 130 may be located in the internal space 162.

According to the present disclosure, the light guide plate 120 and the light guide plate case 130 may be arranged to not be in contact with the light reflector 160. In other words, the light guide plate 120 and the light guide plate case 130 inserted into the reflector hole 161, may be arranged to be spaced apart from the light reflector 160 by a predetermined distance. The temperature of the light reflector 160 may increase due to the heat of the cooking chamber 40. When the light guide plate 120 and the light guide plate case 130 are in contact with the light reflector 160, heat may be transferred from the light reflector 160 to the light guide plate 120 and the light guide plate case 130. As the temperature of the light guide plate 120 and the light guide plate case 130 increases, the temperature of the LEDs 111 adjacent to the light guide plate 120 and the light guide plate case 130 may increase, causing damage to the LEDs 111 due to the high temperature. As described above, the light guide plate 120 and the light guide plate case 130 may be arranged to not be in contact with the light reflector 160, so that heat transfer from the light reflector 160 to the light guide plate 120 and the light guide plate case 130 may be minimized. This may allow heat transfer to the LEDs 111 to be minimized.

The lighting device 100 may include the support bracket 180. The support bracket 180 may secure the light source device 110 and the light guide plate 120 to the electrical chamber 50. The support bracket 180 may be configured to support the light source device 110 and the light guide plate case 130. The light source device 110 and the light guide plate case 130, in which the light guide plate 120 is received, may be coupled to the support bracket 180.

The support bracket 180 may be coupled to the electrical chamber duct 70. The support bracket 180 may include a coupling portion 182 arranged to contact the upper surface of the electrical chamber duct 70. The coupling portion 182 may be provided with a fastening hole. The support bracket 180 may be mounted to the electrical chamber duct 70 by fastening a fastening member, such as a screw, to the fastening hole of the coupling portion 182.

The support bracket 180 may include an inclined surface 181 that is inclined relative to the coupling portion 182. The coupling portion 182 may be arranged to be approximately parallel to the ground, and the inclined surface 181 may be arranged to be inclined at a predetermined angle relative to the coupling portion 182. The inclined surface 181 may be provided with a coupling groove 183. The light source device 110 may be seated in the coupling groove 183. By coupling the light source device 110 to the inclined surface 181 that is inclined with respect to a horizontal direction, the light source device 110 may emit light in a direction that is inclined with respect to the horizontal direction. In addition, by inserting the light guide plate 120 into the light guide plate hole 188 formed in the inclined surface 181, the light guide plate 120 may be arranged in a direction perpendicular to the inclined surface 181. In other words, the light guide plate 120 may be inclined with respect to a vertical direction. As shown in FIG. 12, the light guide plate 120 may be arranged at an angle such that the outgoing light portion 122 faces rearward.

The support bracket 180 may include the first fixing protrusion 184 arranged to be inserted into the substrate hole 112a of the substrate 112. The first fixing protrusion 184 may be inserted into the substrate hole 112a to secure the position of the substrate 112. In other words, the first fixing protrusion 184 may be inserted into the substrate hole 112a to maintain a state in which the substrate 112 is seated in the coupling groove 183.

The support bracket 180 may include a second fixing protrusion 185. The second fixing protrusion 185 may be inserted into a fixing hole 191 of a cover member 190. The second fixing protrusion 185 may be inserted into the fixing hole 191 of the cover member 190 to secure the cover member 190 to the inclined surface 181.

The lighting device 100 may include the cover member 190. The cover member 190 may be coupled to the inclined surface 181 of the support bracket 180. The cover member 190 may be coupled to the inclined surface 181 of the support bracket 180 to cover the inclined surface 181. The cover member 190 may cover the substrate 112 coupled to the coupling groove 183 of the inclined surface 181. By covering the substrate 112, the cover member 190 may prevent foreign substances from entering the substrate 112.

The cover member 190 may include the fixing hole 191 and a second fastening hole 192. The second fixing protrusion 185 of the support bracket 180 may be inserted into the fixing hole 191. In response to the insertion of the second fixing protrusion 185 into the fixing hole 191, the cover member 190 may remain seated on the support bracket 180. The number and position of the fixing holes 191 and the second fixing protrusion 185 may be arranged to correspond. To prevent the cover member 190 from moving on the inclined surface 181, the fixing holes 191 and the second fixing protrusion 185 may be provided in a pair. However, the present disclosure is not limited thereto. The number of the fixing holes 191 and the second fixing protrusion 185 may be varied.

The second fastening hole 192 may be arranged to correspond to a first fastening hole 186 of the support bracket 180. The first fastening hole 186 may be formed on the inclined surface 181 of the support bracket 180. The second fastening hole 192 may be arranged to be positioned corresponding to the first fastening hole 186 when the cover member 190 is seated on the support bracket 180. A fastening member, such as a screw (not shown), may pass through the second fastening hole 192 and be fastened to the first fastening hole 186, thereby allowing the cover member 190 to be coupled to the support bracket 180. The first fastening hole 186 and the second fastening hole 192 may each be provided in a pair to ensure the stability of the coupling between the cover member 190 and the support bracket 180. However, the present disclosure is not limited thereto. The number of the first fastening holes 186 and the second fastening holes 192 may be varied.

The support bracket 180 may include an elastic protrusion 187. The elastic protrusion 187 may be configured to press against one end of a cover plate 193 of the cover member 190. The elastic protrusion 187 may be configured to press against one end of the cover plate 193 to prevent the cover member 190 from deviating from the inclined surface 181 of the support bracket 180.

Referring to FIG. 12, light emitted from the LEDs 111 may be incident into the light guide plate 120 through the incoming light portion 121 of the light guide plate 120. The light incident on the incoming light portion 121 may be totally reflected by the first reflector 123 and the second reflector 124. Light traveling backward inside the light guide plate 120 may be totally reflected at the first reflector 123 and travel forward. Light traveling forward inside the light guide plate 120 may be totally reflected at the second reflector 124 and travel backward. While undergoing the process of being totally reflected by the first reflector 123 and the second reflector 124, the light incident on the incoming light portion 121 may be emitted through the outgoing light portion 122. A portion of the light emitted through the outgoing light portion 122 may pass through the transmission portion 171 and illuminate the interior of the cooking chamber 40. A portion of the light emitted through the outgoing light portion 122 may be reflected by the transmission portion 171 including the scattering surface. The light reflected at the transmission portion 171 may be reflected back toward the transmission portion 171 on the inner surface of the light reflector 160. The light reflected back toward the transmission portion 171 may travel inside the cooking chamber 40 or be reflected back toward the inner surface of the light reflector 160. By the above process, the light loss of the light source device 110 may be reduced.

Referring to FIG. 13, light emitted from the LEDs 111 may be incident into the light guide plate 120 through the incoming light portion 121 of the light guide plate 120. The light incident into the incoming light portion 121 may be totally reflected at the third reflector 125 and the fourth reflector 126. Light traveling to the left inside the light guide plate 120 may be totally reflected at the third reflector 125 and travel to the right. Light traveling to the right inside the light guide plate 120 may be totally reflected at the fourth reflector 126 and travel to the left. While undergoing the process of being totally reflected by the third reflector 125 and the fourth reflector 126, the light incident on the incoming light portion 121 may be emitted through the outgoing light portion 122. A portion of the light emitted through the outgoing light portion 122 may pass through the transmission portion 171 to illuminate the interior of the cooking chamber 40. A portion of the light emitted through the outgoing light portion 122 may be reflected by the transmission portion 171 including the scattering surface. The light reflected by the transmission portion 171 may be reflected back toward the transmission portion 171 on the inner surface of the light reflector 160. The light reflected back toward the transmission portion 171 may travel inside of the cooking chamber 40 or be reflected back toward the inner surface of the light reflector 160. By the above process, the light loss of the light source device 110 may be reduced.

Referring to FIG. 12, the lighting device 100 may be arranged in the electrical chamber 50. The lighting device 100 may illuminate the interior of the cooking chamber 40 by penetrating the electrical chamber duct 70, the base plate 30, and the upper wall 12 of the inner casing 11. The lighting device 100 may be arranged to penetrate the lighting duct opening 74 of the electrical chamber duct 70, the second plate opening 32 of the base plate 30, and the upper wall opening 12a of the upper wall 12.

The lighting device 100 may include the transparent member 170 inserted into the upper wall opening 12a so as to be positioned inside the cooking chamber 40. The transparent member 170 may cover the upper wall opening 12a to block or reduce heat from the inside of the cooking chamber 40 from being transferred to the light source device 110 of the lighting device 100.

Referring to FIG. 12, the LEDs 111 of the lighting device 100 may be positioned spaced upwardly from the cooking chamber 40. As described above, since the LEDs 111 are susceptible to high temperatures, it is necessary to minimize heat transfer from the inside of the cooking chamber 40 to the LEDs 111. The transparent member 170 may cover the upper wall opening 12a formed in the upper wall 12 of the inner casing 11, thereby preventing heat inside the cooking chamber 40 from being transferred directly to the outgoing light portion 122 of the light guide plate 120. The light reflector 160 may cover the upper surface of the transparent member 170, thereby preventing the heat passing through the transparent member 170 from traveling upward. In this process, the temperature of the light reflector 160 may increase, but as described above, the light guide plate 120 and the light guide plate case 130 may not be in contact with the light reflector 160 by being arranged to be spaced apart from the light reflector 160. Accordingly, heat from the light reflector 160 may be prevented from being transferred directly to the light guide plate 120 and the light guide plate case 130.

The insulating layer 41 may be formed outside of the internal space 162 formed between the light reflector 160 and the transparent member 170. The insulating layer 41 may insulate between the cooking chamber 40 and the electrical chamber 50. The insulating layer 41 may prevent or reduce heat inside the cooking chamber 40 from being transferred to the LEDs 111 arranged in the electrical chamber 50. The insulating layer 41 may be provided with an insulating material (not shown). Alternatively, the air inside the insulating layer 41 may act as an insulation.

The cooling flow path 52 or the cooling air layer 52 may be formed on an upper portion of the insulating layer 41. The cooling flow path 52 and the cooling air layer 52 may refer to the exhaust space 52. As described above, the air flowing through the exhaust space 52 may cool the configurations inside the electrical chamber 50. The air flowing through the exhaust space 52 may cool the lighting device 100, and in particular, may cool the LEDs 111.

According to the present disclosure, the transparent member 170, the light reflector 160, the insulating layer 41, and the cooling flow path 52 may be arranged between the cooking chamber 40, which is at a high temperature, and the LEDs 111. The second light barrier 150 may be cooled by being positioned on the cooling flow path 52. The first light barrier 140 may be positioned on the second light barrier 150. The light blocking portion 142 of the first light barrier 140 may cover the connection hole 151 of the second light barrier 150, thereby preventing heat inside the passage portion 153 from being transferred to the LEDs 111 positioned above the light blocking portion 142.

By the heat blocking and cooling structure described above, the LEDs 111 may not be damaged by the heat inside the cooking chamber 40 even though the temperature inside the cooking chamber 40 increases.

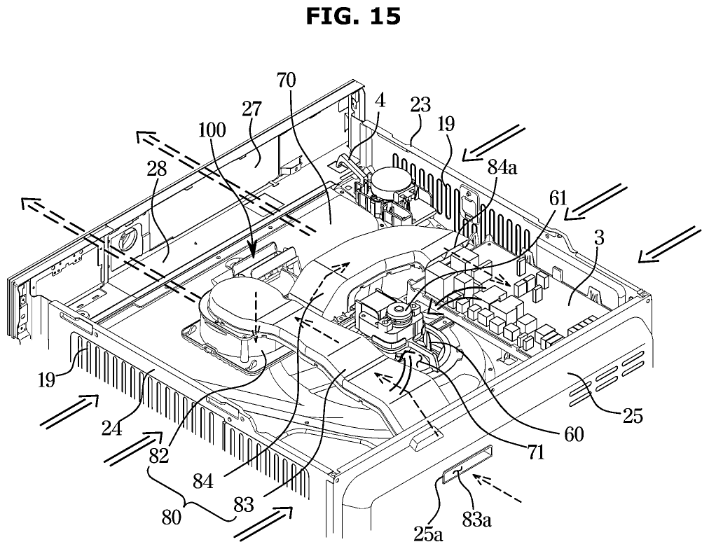

FIG. 14 is a perspective view of the cooking apparatus according to an embodiment, with the upper plate removed. FIG. 15 is a view showing an air flow by the electrical chamber cooling fan and an air flow by the camera cooling fan of the cooking apparatus according to an embodiment. FIG. 16 is a view of the air flow by the electrical chamber cooling fan of the cooking apparatus according to an embodiment.

Hereinafter, with reference to FIGS. 14 to 16, air flow inside the electrical chamber 50 of the cooking apparatus 1 will be described.

As shown in FIGS. 14 to 16, the cooking apparatus 1 may include the electrical chamber cooling fan 60 configured to cool the entire electrical chamber 50 and the camera cooling fan 85 configured to intensively cool the camera 80.

In response to the operation of the electrical chamber cooling fan 60, air from outside the main body may be drawn into the electrical component space 51, and from the electrical component space 51 may be drawn into the inlet 71 of the electrical chamber duct 70. The air drawn into the inlet 71 of the electrical chamber duct 70 may be discharged through the exhaust space 52 and to the outside of the main body 10 through the outlet 72. In such a process, the electrical chamber cooling fan 60 may form a first air flow (see the double line arrow in FIG. 15 and FIG. 16). The first air flow may cool the entire electrical chamber 50. For example, the first air flow may cool the lighting device 100. In addition, the first air flow may form the air insulating layer 41 described above while flowing inside the exhaust space 52.

In response to the operation of the camera cooling fan 85, air from outside the main body 10 may be drawn into the camera cooling duct 81. The air drawn into the camera cooling duct 81 may cool the camera 80 and be discharged into the electrical component space 51. In other words, the camera cooling fan 85 may form a second air flow (see the single line arrow in FIG. 15). The second air flow may directly guide air from outside the main body 10 to the camera 80. As a result, the second air flow may intensively cool the camera 80. In addition, the second air flow may cool the camera 80 and then be discharged into the electrical component space 51, thereby also cooling the electrical component space 51.

The cooking apparatus 1 according to an embodiment may include the main body 10 including the inner casing 11, the cooking chamber 40 formed inside the inner casing, and the electrical chamber 50 formed outside the inner casing, the heating devices 5 and 8 configured to heat the cooking chamber, the base plate 30 arranged on the upper side of the inner casing to form the insulating layer 41 between the electrical chamber and the inner casing, and the lighting device 100 arranged in the electrical chamber and configured to illuminate the interior of the cooking chamber. The lighting device may include the LED 111 arranged on the upper side of the insulating layer, the light guide plate 120 configured to guide light emitted from the LED from above the insulating layer to below the insulating layer, and the transparent member 170 configured to cover the opening 12a formed on the upper surface of the cooking chamber and to transmit light emitted through the light guide plate.

The lighting device may further include the light reflector 160 configured to cover the transparent member above the transparent member and to reflect light, which is reflected from the transparent member without passing through the transparent member, toward the transparent member.

The light guide plate may include the incoming light portion 121 arranged to face the LED, and the outgoing portion 122 arranged to face the incoming light portion.

The outgoing light portion may be arranged in the internal space 162 formed between the light reflector and the transparent member.

The outgoing light portion may have a rectangular or square shape to allow the light irradiation area L in which light emitted through the outgoing light portion is irradiated to have a corresponding rectangular or square shape.

The light reflector may include the reflector hole 161 into which at least a portion of the light guide plate is inserted to allow the outgoing light portion to pass through the light reflector and be positioned in the internal space.

The light guide plate inserted into the reflector hole may be arranged to be spaced apart from the light reflector to prevent heat from the light reflector from being transferred directly to the light guide plate.

The cooking apparatus may further include the electrical chamber duct 70 coupled to the base plate such that the electrical chamber duct covers at least a portion of the upper surface of the base plate.

The cooling flow path 52 through which air flows may be formed between the electrical chamber duct and the base plate.

The LED may be arranged on the upper side of the insulating layer and the cooling flow path to reduce heat transfer from the interior of the cooking chamber to the LED.

The electrical chamber duct may include the duct opening 74 through which the light guide plate passes.

The lighting device may further include the first light barrier 140 configured to cover the duct opening to prevent light emitted outside the light guide plate from passing through the duct opening.

The first light barrier may include the insertion hole 141 into which the light guide plate is inserted.

The light guide plate may pass through the duct opening by passing through the insertion hole.

The base plate may include the plate opening 32 configured to allow the light guide plate to pass through and corresponding to the duct opening.

The lighting device may further include the second light barrier 150 inserted into the duct opening and the plate opening, the second light barrier 150 including the connection hole 151 through which the light guide plate passes, and the passage portion 153 configured to surround the light guide plate.

The lighting device may further include the support bracket 180 coupled to the electrical chamber duct and configured to support the LED and the light guide plate.

The support bracket may include the inclined surface 181 arranged to be inclined relative to the electrical chamber duct.

The substrate 112 on which the LED is mounted may be arranged to face the inclined surface, so that the LED may face a lower rear side.

The lighting device may further include the light guide plate case 130 configured to receive the light guide plate.

The light guide plate and the light guide plate case may be inserted into the light guide plate hole 188 formed on the inclined surface such that the outgoing light portion of the light guide plate faces the lower rear side.

The light guide plate case may be configured to include a metallic material having a high thermal conductivity so that the light guide plate received in the light guide plate case and the light guide plate case is easily cooled.

The transparent member may include the scattering surface configured to disperse light emitted from the outgoing light portion.

According to the spirit of the present disclosure, the cooking apparatus including a structure capable of reducing heat transfer from the cooking chamber to the LEDs to prevent damage to the LEDs due to heat inside the cooking chamber can be provided.

According to the spirit of the present disclosure, the cooking apparatus may be provided in which the LEDs is installed to be spaced apart from the cooking chamber, thereby effectively blocking heat transfer to the LEDs and cooling the LEDs.

According to the spirit of the present disclosure, the cooking apparatus may be provided in which the light irradiation area of the lighting device is provided in a rectangular or square shape to illuminate the entire area of the tray.

While the present disclosure has been particularly described with reference to exemplary embodiments, it should be understood by those of skilled in the art that various changes in form and details may be made without departing from the spirit and scope of the present disclosure.

1. A cooking apparatus comprising:
a main body including an inner casing, a cooking chamber inside the inner casing, and an electrical chamber outside the inner casing;
a base plate on an upper side of the inner casing and forming an insulating layer between the electrical chamber and the inner casing; and
a lighting device in the electrical chamber and including:
a light-emitting diode (LED) on an upper side of the insulating layer,
a light guide plate configured to guide light emitted from the LED from above the insulating layer to below the insulating layer, and
a transparent member covering an opening on an upper surface of the cooking chamber and configured to transmit the light guided by the light guide plate to an interior of the cooking chamber to illuminate the interior of the cooking chamber.

2. The cooking apparatus of claim 1, wherein the lighting device further includes:
a light reflector above the transparent member and configured to reflect light, which is reflected from the transparent member without passing through the transparent member, toward the transparent member.

3. The cooking apparatus of claim 2, wherein
the light guide plate includes an incoming light portion facing the LED, and an outgoing light portion facing the incoming light portion, and
the outgoing light portion is in an internal space between the light reflector and the transparent member.

4. The cooking apparatus of claim 3, wherein the outgoing light portion has a rectangular or square shape to allow an area in which light emitted through the outgoing light portion is irradiated to have a corresponding rectangular or square shape.

5. The cooking apparatus of claim 3, wherein the light reflector includes:
a reflector hole into which at least a portion of the light guide plate is inserted to allow the outgoing light portion to pass through the light reflector and be positioned in the internal space, and
the light guide plate inserted into the reflector hole is spaced apart from the light reflector to prevent heat from the light reflector from being transferred directly to the light guide plate.

6. The cooking apparatus of claim 1, further comprising:
an electrical chamber duct coupled to the base plate so that the electrical chamber duct covers at least a portion of an upper surface of the base plate,
wherein a cooling flow path through which air flows is between the electrical chamber duct and the base plate.

7. The cooking apparatus of claim 6, wherein the LED is on an upper side of the insulating layer and the cooling flow path to reduce heat transfer from the interior of the cooking chamber to the LED.

8. The cooking apparatus of claim 6, wherein
the electrical chamber duct includes a duct opening through which the light guide plate passes, and
the lighting device further includes a first light barrier covering the duct opening to prevent light emitted outside the light guide plate from passing through the duct opening.

9. The cooking apparatus of claim 8, wherein
the first light barrier includes an insertion hole into which the light guide plate is inserted, and
the light guide plate passes through the duct opening by passing through the insertion hole.

10. The cooking apparatus of claim 8, wherein
the base plate includes a plate opening configured to allow the light guide plate to pass through and corresponding to the duct opening, and
the lighting device further includes a second light barrier inserted into the duct opening and the plate opening, the second light barrier including a connection hole through which the light guide plate passes, and a passage portion configured to surround the light guide plate.

11. The cooking apparatus of claim 6, wherein the lighting device further includes:
a support bracket coupled to the electrical chamber duct and supporting the LED and the light guide plate.

12. The cooking apparatus of claim 11, wherein
the support bracket includes an inclined surface inclined relative to the electrical chamber duct, and
the cooking apparatus further includes a substrate, on which the LED is mounted, facing the inclined surface so that the LED faces a rear lower side.

13. The cooking apparatus of claim 12, wherein
the light guide plate includes an incoming light portion facing the LED, and an outgoing light portion facing the incoming light portion,
the lighting device further includes:
a light guide plate case in which the light guide plate is received, and
the light guide plate and the light guide plate case are inserted into an light guide plate hole on the inclined surface so that the outgoing light portion of the light guide plate faces the rear lower side.

14. The cooking apparatus of claim 13, wherein the light guide plate case includes a metallic material having a high thermal conductivity so that the light guide plate received in the light guide plate case and the light guide plate case are easily cooled.

15. The cooking apparatus of claim 1, wherein
the light guide plate includes an incoming light portion facing the LED, and an outgoing light portion facing the incoming light portion, and
the transparent member includes a scattering surface configured to disperse light emitted from the outgoing light portion.
